(19) United States
(12) Patent Application Publication
(10) Pub. No.: US 2008/0149446 A1
(43) Pub. Date: Jun. 26, 2008

(54) HYDRAULIC CLUTCH CIRCUIT

(76) Inventor: Raymond Schuurman, Metepec (MX)

Correspondence Address: Striker, Striker & Stenby, 103 East Neck Road, Huntington, NY, 11743, US

(21) Appl. No.: 11/957,527

(22) Filed: Dec. 17, 2007

(30) Foreign Application Priority Data
Dec. 22, 2006 (DE) 102006061344.9

(51) Int. Cl. F16D 48/02

(52) U.S. Cl. 192/3.58

(57) ABSTRACT

In a method and an apparatus for diagnosis of at least one clutch that is provided in a hydraulic circuit, the actuation of the at least one clutch is effected via a pressure regulator that adjusts a pilot control pressure, and the course of the pilot control pressure, or a suitable electrical variable of the pressure regulator, is monitored, in order to detect a characteristic load change in the hydraulic circuit that occurs in a clutch shifting process.

### CROSS-REFERENCE TO A RELATED APPLICATION

The invention described and claimed hereinbelow is also described in German Patent Application DE 102006061344.9 filed on Dec. 22, 2006. This German Patent Application, whose subject matter is incorporated here by reference, provides the basis for a claim of priority of invention under 35 U.S.C. 119(a)-(d).

### BACKGROUND OF THE INVENTION

In automatic transmissions, of the kind used for instance in motor vehicles, hydraulically actuated clutches are used as a rule. Within the automatic transmission, hydraulic circuits are associated with the clutches; in these circuits, the pilot control, for instance, is effected using an electromagnetically actuated seat valve. The electromagnetically actuated seat valve triggers a slide downstream of it that adjusts the actual clutch pressure with which the clutch is acted upon.

Clutches that are hydraulically actuated have two different elasticities, dictated by their construction. One elasticity has to do with the pressure elasticity and the other to the volumetric elasticity of the clutch. During the filling phase of the clutch with a hydraulic fluid, a high volumetric flow is carried to the clutch, and with it the lamination packet or packets of the clutch are displaced. Once the filling phase of the clutch is ended, the elasticity of the clutch is substantially less, and a substantially lesser volumetric flow is carried to the clutch. For the sake of a controlled pressure buildup inside the clutch, the filling instant of the clutch must be detected exactly. In the prior art, recourse is had for this purpose to pressure switches. These pressure switches switch as a function of the volumetric flow and thus determine the instant at which a switchover is made from a high volumetric flow to a low volumetric flow—precisely after the ending of the filling phase of the clutch.

The switchover of a slide, downstream of the pressure regulator that can for instance be embodied as a seat valve, from a high volumetric flow to a lower volumetric flow and vice versa means a load change, which makes itself felt in the form of a pressure change, for the pressure regulator, or in other words for instance for a seat valve.

### SUMMARY OF THE INVENTION

According to the invention, it is proposed that the pilot control pressure for actuating a clutch, this pressure being set by the pressure regulator, be monitored and that a load change at the pressure regulator, which may for instance have a seat valve, be detected.

By means of the at least one pressure sensor, which—as proposed according to the invention—may either be upstream of a throttle restriction for filling a hydraulic slide or downstream of the throttle restriction and upstream of the hydraulic slide, pressure dips or pressure peaks that become established during a shifting event can be detected. Thus load changes that act on the pressure regulator and can be caused for instance by the switchover from a high volumetric flow, prevailing during the filling phase of the clutch, to a lower volumetric flow and vice versa, can be detected. These load changes can be detected by means of at least one pressure sensor, so that from the dependency of the pilot control pressure course, a conclusion can be drawn about the end, or the beginning and end, of the filling phase of a clutch to be filled, and the at least one pressure switch employed in the prior art can be dispensed with.

The change in the hydraulic load upon switchover from a low volumetric flow to a high volumetric flow and vice versa moreover causes the pressure regulator to readjust the load change by varying the degree to which the seat of the pressure regulator, such as a seat valve embodied for instance as a flat seat valve, opens. The change in the seat opening at the pressure regulator is in turn associated with a change in the inductance of the final control element of the pressure regulator. The change in the seat opening makes itself felt in the course of the electrical trigger signal of the pressure regulator, which can likewise be used for detecting a load change at the pressure regulator.

For detecting a load change in the hydraulic circuit, an electrical variable at the pressure regulator can also be used, such as the inductance of its magnetic coil. Hence the filling time of the clutch, that is, the onset of filling and the end of filling, can be determined from the course of the electrical signal. By means of the proposals according to the invention, the end of the filling phase of a clutch can be detected either from a resultant change in the hydraulic load that is detected via the at least one pressure sensor, or by providing that the pressure regulator indicates the load change that has occurred by means of a change in the inductance within its magnet circuit, because of the load change that has occurred.

In hydraulic circuits for actuating automatic transmissions, pressure sensors are provided anyway, for monitoring the pressure regulator, which is a valve, such as a seat valve; thus in the provisions proposed by the invention, pressure switches that are associated with a slide downstream of the pressure regulator, can be dispensed with. Hydraulic circuits that are used to actuate automatic transmissions include at least one pressure regulator, which sets the pressure level with which a slide or the like, downstream of the pressure regulator, is acted upon for filling a clutch. For that purpose, a variable throttle restriction is provided as a rule, with which the pressure level can be set. Between the pressure regulator and a slide downstream of it, a further throttle restriction may be provided.

A pressure sensor can for instance be upstream or downstream of this further throttle restriction. In a first installation position, the pressure sensor is located upstream of the throttle restriction; in a second installation position, the pressure sensor is located downstream of the throttle restriction, but upstream of the slide. A filling pump for filling the slide with hydraulic medium is provided at the slide, as is a low-pressure outlet. In addition, at least one line branches off from the slide to at least one clutch to be actuated, and in it the clutch pressure that has finally been set is built up.

From the housing of the slide, a hydraulic line extends to the line by way of which the clutch pressure that has been set is delivered to the clutch. The clutch can include at least one clutch spring, by which a soft characteristic is set during the filling phase of the clutch. After the termination of the filling phase of the clutch, a harder characteristic can prevail in the clutch, for instance as a result of a further clutch spring that becomes operational, after partial compression of the first clutch mentioned.

Regardless of whether the load change in the hydraulic circuit for actuating the at least one clutch is detected via a hydraulic variable, such as the pilot control pressure course, or an electrical variable, such as the change in inductance in a magnet coil of a pressure regulator, the actuation of the at least one clutch is effected by means of a signal of the control unit. By the method proposed according to the invention, the onset and/or end of a filling phase of at least one clutch, or a corresponding signal is forwarded to the control unit, which actuates the at least one clutch of an automatic transmission. Via the control unit, the pressure regulator is actuated for setting the pilot control pressure. Thus after the conclusion of the filling phase of a first clutch, for instance, the filling of a further, second clutch of an automatic transmission can be initiated, so that overlapping filling of individual clutches can be achieved.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a hydraulic circuit in the prior art, in which a pressure switch is associated with a slide for filling a clutch;

FIG. 2 shows an embodiment of the hydraulic circuit proposed according to the invention, having at least one pressure sensor located at two different installation positions;

FIG. 3 is a graph comparing the pilot control pressure and clutch pressure courses at the onset of the filling phase of a clutch; and

FIG. 4 is a graph comparing the courses of the pilot control pressure and the filling pressure of the clutch after the termination of the filling phase.

### DESCRIPTION OF THE PREFERRED EMBODIMENTS

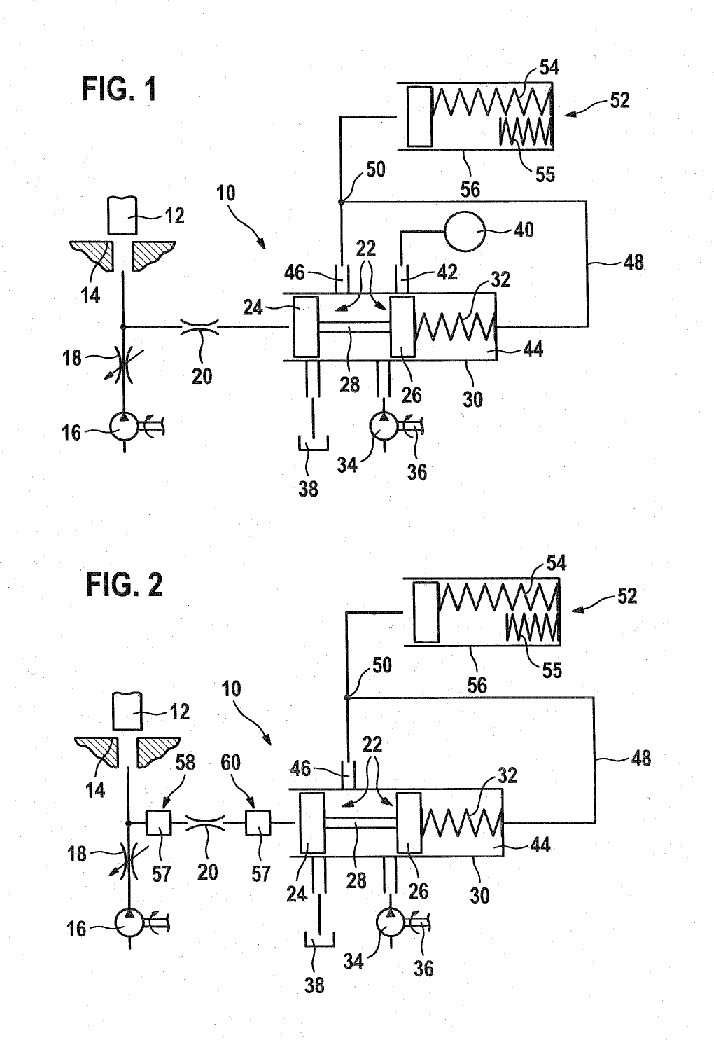

FIG. 1 is a schematic diagram of a hydraulic circuit in accordance with the prior art.

A hydraulic circuit 10 shown in FIG. 1 includes a pressure regulator, in the form of a seat valve 12, which opens, closes, or partially opens a seat 14. Via the pressure regulator 10 embodied as a seat valve, the volumetric flow of a hydraulic pressure source 16 is regulated. The volumetric flow is set at a variable throttle restriction 18. From the hydraulic line that extends between the pressure regulator 12 and the hydraulic pressure source 16, a line branches off in which a diaphragm 20 is received and which extends to a hydraulic slide 22. The hydraulic slide 22 includes a first slide portion 24, embodied in disklike fashion, and a second slide portion 26, also embodied in disklike fashion, which are connected to one another via a slide rod 28. The slide 22 having the first slide portion 24 and the second slide portion 26 is received in a housing 30. The housing 30 is acted upon by a hydraulic medium, via a filling pump 34. On the rearward side of the second slide portion 26, the slide 22 is acted upon via a spring element 32, which is braced on the housing 30 of the slide 22. A leaking oil outlet 38 is also connected to the housing 30 of the slide 22.

In addition, a connection 42 for the pressure switch 40 is associated with the housing 30 of the slide 22, and this connection is either closed or opened by the second slide portion 26 of the slide 22, so that the pressure operative in the interior of the housing 30 acts on the pressure switch 40. Also associated with the housing 30 of the slide 22 is a connection 46 at which the pressure level to which at least one clutch 52 is subjected prevails. Via a hydraulic line, which extends from the connection 46 of the housing 30 of the slide 22 to the at least one clutch 52, the transmission is effected of the pressure, set by the slide 22, to the at least one clutch 52. A line 48 also extends from the housing 30 of the slide 22; by way of it, the hydraulic pressure level in the interior of the housing 30 is transmitted to a union 50.

In the clutch 52 shown schematically in FIG. 1, there are both a first clutch spring 54 and at least one further clutch spring. Via the first clutch spring 54, a soft clutch characteristic that prevails during the filling phase of the clutch 52 is set.

It can be seen from FIG. 1 that the pressure to which the slide 22 is subjected is transmitted, depending on the position of the slide portions 24, 26 to the pressure switch 40 via the connection 42.

In the view in FIG. 2, the configuration proposed according to the invention of a hydraulic circuit for an automatic transmission of a vehicle is shown.

It can be seen from FIG. 2 that once again, the hydraulic circuit 10 includes a pressure regulator in the form of a seat valve 12, and depending on the volumetric flow of hydraulic fluid flowing via the variable throttle restriction 18, the slide 22 is subjected to hydraulic fluid. The diaphragm 20 is located in the hydraulic line, between the pressure regulator 12 and the slide 22; a pressure sensor 57 can either be upstream of the diaphragm, in a first installation position 58, or a pressure sensor 57 may be downstream of it, in a second installation position 60, the pressure sensor being located between the diaphragm 20 and the slide 22. It is also possible for a respective pressure sensor 57 to be located both upstream and downstream of the diaphragm 20, or in other words in both installation positions 58 and 60.

Because of the at least one pressure sensor 57 which is located upstream of the slide 22, the pressure switch that in the view in FIG. 1 is associated with the slide 22 can be dispensed with. The pressure switch 40—as shown in FIG. 1—used previously is on the one hand an expensive built-in part, and on the other, it has a tendency to premature failure because of soiling that occurs during operation. Overall, the pressure switch is a component that reacts quite sensitively to soiling of the hydraulic fluid with particles, and besides its premature failure from the effect of soiling, it has a tendency to premature leakage, which is likewise extremely undesirable during operation.

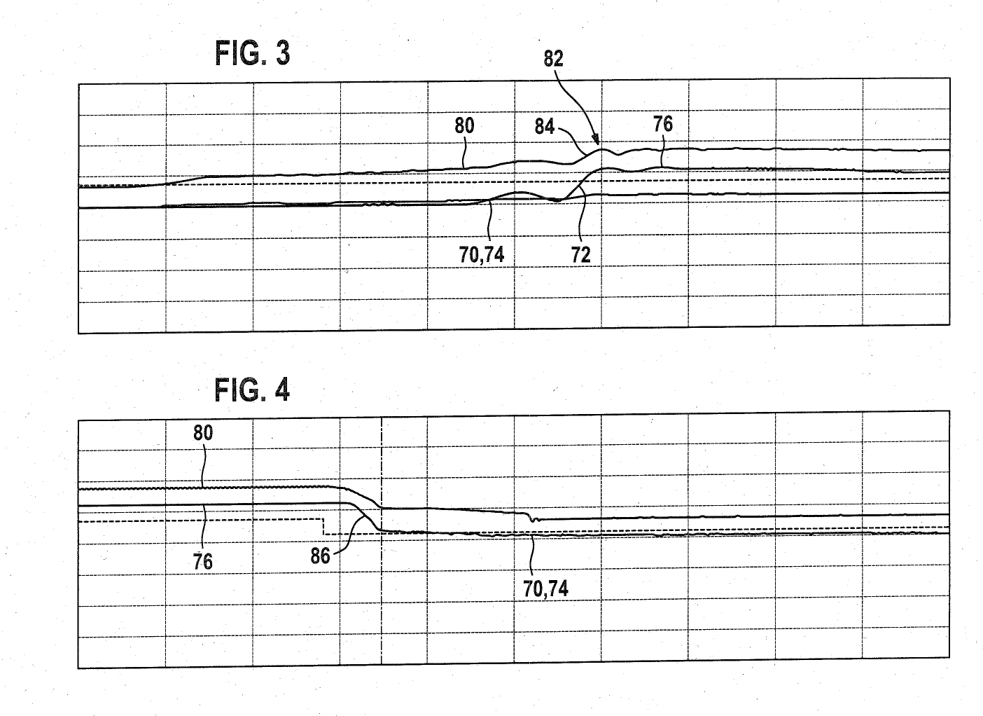

By means of the at least one pressure sensor 57, pressure changes that the pressure regulator 12 experiences as load changes, as shown in FIGS. 3 and 4, can be detected. For monitoring the function of the pressure regulator 12, which is preferably embodied as a seat valve, a pressure sensor is required, which in accordance with the provisions proposed by the invention is consequently used to detect pressure courses inside the hydraulic circuit, and in particular to detect the filling phase of the clutch.

Triggering of the pressure regulator 12, preferably embodied as a seat valve, and thus for instance of the electromagnet that actuates it, requires a constant voltage signal. A change in the cross section at the seat 14 upon actuation of the pressure regulator 12 preferably embodied as a seat valve causes a sudden change in the pilot control pressure, and this change is detected upstream of the slide 22 by the at least one pressure sensor 57, whether it is in the first installation position 58 upstream of the diaphragm 20 or in the second installation position 60 downstream of the diaphragm 20. The sudden pressure change that occurs in the hydraulic line that contains the diaphragm 20 acts on the face end of the first slide portion 24 of the slide 22. Accordingly, the slide is deflected out of its position of repose inside the housing 30 and it operates counter to the action of the spring element 32 that is received in the housing 30 of the slide 22.

Depending on the deflection of the first slide portion 24 or the second slide portion 26, which are connected to one another via the slide rod 28, either a connection port to the leaking oil reservoir 38 or a connection port to which the filling pump 34 is connected is opened. The filling pump 34 is driven via a drive mechanism 36. Via its drive mechanism 36, the filling pump 34 can be driven as a function of the engine rpm, and it is typically designed in such a way that it has an adjustable stroke volume. The pilot control pressure source 16 can also be implemented, but at a lower pressure level, by way of the filling pump 34, which is associated with the unit that adjusts the clutch pressure.

The clutch pressure to be adjusted at the connection 46 also prevails in a hydraulic line 48, which extends from the housing 30 of the slide 22 to a union 50. The pressure level at the connection 46 for the clutch pressure and the pressure level in the hydraulic fluid line 48 are identical. With the clutch pressure to be adjusted, which via the pilot control pressure brings about a corresponding positioning of the slide 22 inside the housing 30, counter to the action of the spring element 32, the clutch pressure applied to the clutch 52 is determined. The clutch 52 includes both the first clutch spring 54 and a second clutch spring 55 located parallel to the first.

During the filling phase of the clutch 52, or in other words during the period of time in which the hollow chamber in the clutch 52 is filled with a high volumetric flow, the first restoring spring 54 is operative. After the conclusion of the filling of the hydraulic chamber of the clutch 52, a clutch disk is acted upon, not only by the first clutch spring 54 but also by the second clutch spring 55, which changes the characteristic of the clutch 52. Once the filling phase of the hollow chamber in the clutch 52 is concluded, a switchover is made from a high volumetric flow to a lower volumetric flow. The switchover from the high volumetric flow to a lower volumetric flow is effected by providing that the second slide portion 26 of the unit 22, which adjusts the clutch pressure and is connected to the first slide portion 24, partly closes the connection port of the filling pump 34, so that the volumetric flow of hydraulic medium entering via this connection port is reduced.

The mode of operation of the hydraulic circuit proposed according to the invention and shown in FIG. 2 is as follows:

Once the hollow chamber in at least one clutch 52 is filled, a predetermined pilot control pressure is set at the pressure regulator 12; this pilot control pressure is applied to the slide 22 by the pilot control pressure source 16 and the variable throttle restriction 18 via at least one pressure sensor 57. The first slide portion 24, acted upon by the pilot control pressure, is displaced inside the housing 30 in accordance with the pilot control pressure, so that the connection for the filling pump 34 is opened. The filling pump 34 is driven by a drive mechanism 36 and fills the hollow chamber 44 in the slide with a hydraulic fluid. The hydraulic fluid flows, via the also-opened connection 46 and via the union 50, to the hollow chamber in the clutch 52 and fills this hollow chamber.

The pressure prevailing in the hollow chamber 44 of the slide also prevails at the union 50, via the hydraulic fluid line 48. Once the filling phase of the at least one clutch 52 is concluded, or in other words the first clutch spring 54 is compressed, then by the action of the second clutch spring 55, a pressure wave rises and is reflected into the hollow chamber 44 in the slide or in other words returns to it. The pressure wave returning to the hollow chamber 44 of the slide 22 causes a deflection of the slide 22. The deflection of the slide 22 in turn causes a pressure change in the line in which the at least one pressure sensor 57 is located and is accordingly detected by this sensor as a hydraulic load change. In this way, the end of the filling phase of the at least one clutch 52 can be detected.

The detection of the onset of the filling phase of the clutch 52 is effected in that, upon a corresponding triggering of the pressure regulator 12, a load change, resulting from a high volumetric flow, occurs in the line which receives the throttle restriction 20 and in which the at least one pressure sensor 57 is located. The detection of the end of the filling phase of the hollow chamber in the clutch 52 is effected in that upon a corresponding triggering of the pressure regulator 12 in the line receiving the throttle restriction 20, in which line the at least one pressure sensor 57 is located, a load change, in the form of a lower volumetric flow as a result of a temporary closure of the connection port for the filling pump 34, is detected as a hydraulic load change.

An increase in the pilot control pressure in the line that contains the throttle restriction 20 leads to the deflection of the slide 22 and to the opening of the connection at which the filling pump 34 is connected. Via the filling pump 34 and the hollow chamber 44 in the slide, hydraulic fluid now flows via the connection 46 to the hollow chamber in the clutch, so that the clutch can be filled with a high volumetric flow.

FIG. 3 shows the pressure buildup phase at the unit 22 that adjusts the clutch pressure.

From the graph in FIG. 3, it can be seen that in accordance with a course 70 of the clutch pressure in the at least one clutch 52, this clutch initially remains at a first pressure level 74, in accordance with the pilot control pressure 80. Reference numeral 72 indicates a ramp for a pressure buildup within the at least one clutch 52. In order to switch from the first pressure level 74 to a second, higher pressure level 76, a change in the pilot control pressure 80 is necessary. The change in the pilot control pressure 80 is effected by the actuation of the pressure regulator 12, preferably embodied as a seat valve. Upon its actuation, a fluctuation 82 ensues in the pilot control pressure. The pressure fluctuation 82 includes at least one pressure drop (hydraulic dip) before or after an approximately ramplike increase in pilot control pressure; see reference numeral 84 in FIG. 3.

The pilot control pressure increase 84 extending in ramplike fashion in FIG. 3 is detected by the at least one pressure sensor 57. In the line in which the pressure sensor 57 can be built in at either a first installation position 58 or a second installation position 60, a component acting as a diaphragm 20 can optionally be provided. If, in the unit 22 that adjusts the clutch pressure, the connection port of the filling pump 34 is opened as a result of the deflection of the first and second slide portions 24, 26, then the hollow chamber 44 in the slide of the unit 22 that adjusts the clutch pressure is subjected to hydraulic fluid. Accordingly, via the connection 44, the at least one clutch 52 is filled with a high volumetric flow. Once it is filled, then a pressure reduction 86 extending in ramplike fashion ensues, as shown in conjunction with FIG. 4.

Once the filling of the hollow chamber of the at least one clutch 52 has ended, a pressure wave returns to the hollow chamber 44 of the slide of the unit 22 that adjusts the clutch pressure, and via the first slide portion 24 flows into the hydraulic line that optionally contains at least one diaphragm 20, where it is detected by the pressure sensor 57.

The load change that occurs at the onset of the filling phase of the at least one clutch 52, and at the end of the filling phase of the at least one clutch 52, or in other words the switchover from a high volumetric flow for filling the at least one clutch 52 to a lower volumetric flow after filling of the at least one clutch 52, causes the pressure regulator 12, which is preferably embodied as a seat valve, to readjust the pressure change. This is done by changing the opening of the seat 14. A change in the degree of opening of the seat 14 is associated with a change in the inductance, which makes itself felt in the course of the electrical trigger signal of the pressure regulator 12.

The time required for filling the at least one clutch 52 can thus likewise be determined from the course of the electrical signal. Besides the possibility, sketched above, of detecting a hydraulic load change by means of at least one pressure sensor 57, the pressure regulator 12 itself, or its magnet valve, can also be used for detecting a load change. A hydraulic load change can also be detected inside the pressure regulator 12 by detecting the inductance during the load change, inside the magnetic circuit of the pressure regulator 12. A change in the inductance in the magnetic circuit of the pressure regulator 12 can likewise be used for detecting the [noun missing] of a filling phase of at least one clutch 52 or for detecting the onset of a filling phase of a pressure regulator 12.

The actuation of the at least one clutch 52, in particular in an automatic transmission of a motor vehicle, is effected by way of a control unit associated with it. The control unit furnishes the signals for actuating the pressure regulator 12, which regulates the pilot control pressure course 80, for the particular clutch 52. Depending on the signal detected with respect to the change in the pilot control pressure course 80, a signal is generated in the control unit, in a shifting process of the at least one clutch 52, that triggers the pressure regulator 12 to vary the pilot control pressure and brings about an increase or reduction in the pilot control pressure.

By way of the increase or reduction of the pilot control pressure, the unit 22 that adjusts the clutch pressure 74, 76 is triggered accordingly. The triggering of the pressure regulator 12 associated with the particular clutch 52 is effected via the control unit and can be adapted in such a way that toward the end of the filling phase of a first clutch 52, the filling of a further, second clutch 52 is already initiated, so that overlapping filling of individual clutches 52 of an automatic transmission is effected.

The generation of the trigger signals for the individual pressure regulators 12 for actuating the clutches 52 with the interposition of the unit 22 that adjusts the clutch pressure is effected regardless of whether, by means of the method proposed according to the invention, the change in a hydraulic variable, such as the pilot control pressure in the hydraulic circuit 10, or the change in an electrical variable, or a change in a signal corresponding to it, such as the inductance of a magnetic coil of the pressure regulator 12, is detected.

It will be understood that each of the elements described above, or two or more together, may also find a useful application in other types of methods and apparatuses differing from the type described above.

While the invention has been illustrated and described as embodied in a hydraulic clutch circuit, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for diagnosis of at least one clutch in a hydraulic circuit, in which an actuation of the at least one clutch is effected via a pressure regulator that adjusts a pilot control pressure, the method comprising the steps of monitoring the pilot control pressure or a suitable electrical variable of the pressure regulator; and detecting, based on the monitoring, a characteristic load change in the hydraulic circuit in a clutch shifting position.

2. A method as defined in claim 1, further comprising recognizing an onset of a filling phase of the at least one clutch by detecting a pressure fluctuation of the pilot control pressure.

3. A method as defined in claim 1, further comprising detecting an end of a filling phase of the at least one clutch, on a basis of a change in a position of at least one slide portion inside a unit that adjusts a clutch pressure, by at least one pressure sensor between the unit that adjusts the clutch pressure and the pressure regulator.

4. A method as defined in claim 1, further comprising, at an onset of a filling phase of the at least one clutch, adjusting by a unit that adjusts a clutch pressure a volumetric flow of a hydraulic fluid from low to high; and at an end of the filling phase of the at least one clutch switching it from high to low.

5. A method as defined in claim 1, further comprising detecting a change in the electrical variable in a magnet circuit of the pressure regulator that occurs in the pressure regulator upon a change in an opening cross-section of a seat by the pressure regulator, in a course of an electrical signal of the pressure regulator as a function of a hydraulic load change.

6. An apparatus for diagnosis of at least one clutch in a hydraulic circuit, in which an actuation of the at least one clutch is effected via a pressure regulator that adjusts a pilot control pressure, the apparatus comprising means for monitoring a pilot control pressure or a suitable electrical variable of the pressure regulator in order to detect a characteristic load change in the hydraulic circuit in a clutch shifting process.

7. An apparatus as defined in claim 6, further comprising at least one pressure sensor located between a unit that adjusts a clutch pressure and the pressure regulator.

8. An apparatus as defined in claim 7, further comprising a diaphragm which in a first installation position is located upstream of said at least one pressure sensor.

9. An apparatus as defined in claim 7, further comprising a diaphragm located in a second installation position downstream of said at least one pressure sensor, wherein said unit that adjusts the clutch pressure is located upstream of the at least one pressure sensor.

10. An apparatus as defined in claim 7, wherein said at least one pressure sensor is located in a hydraulic line that is acted upon by a pilot control pressure source.

11. An apparatus as defined in claim 7, wherein said unit that adjusts a clutch pressure has a first slide portion and a second portion, which opens or closes one connection with the at least one clutch, one connection with a leaking oil, and one connection with a filling pump.

12. An apparatus for diagnosis of at least one clutch in a hydraulic circuit, in which an actuation of the at least one clutch is effected via a pressure regulator that adjusts a pilot control pressure, and the pilot control pressure or a suitable electrical variable of the pressure regulator is monitored in order to detect a characteristic load change in the hydraulic circuit in a clutch shifting position, the apparatus comprising means for monitoring the suitable electrical variable of the pressure regulator selected from the group consisting of an inductance of its magnetic portion and a signal corresponding to the inductance.
